(19) United States
(12) Patent Application Publication
(10) Pub. No.: US 2024/0174113 A1
(43) Pub. Date: May 30, 2024

(54) ENERGY MANAGEMENT METHOD FOR ELECTRIC COMMERCIAL VEHICLES

(71) Applicant: Volvo Truck Corporation, GÖTEBORG (SE)

(72) Inventor: Devraj DUTT, Göteborg (SE)

(21) Appl. No.: 18/285,403

(22) PCT Filed: Apr. 7, 2021
(86) PCT No.: PCT/IB2021/052880

§ 371 Date: Oct. 3, 2023

(51) Int. Cl. B60L 53/66; B60L 53/62; B60L 53/63; B60L 53/67; B60L 55/00

(52) U.S. Cl. CPC B60L 53/665; B60L 53/62; B60L 53/63; B60L 53/67; B60L 55/00; B60L 2240/62; B60L 2240/662; B60L 2240/80

(57) ABSTRACT

An electric vehicle energy management method and system includes obtaining, from a grid interface, grid data indicative of an energy purchase price, an energy re-sale price, and a plurality of charging locations. The data is obtained from a vehicle management controller, including vehicle data indicative of mission information, an energy requirement associated with the mission, and an estimated charging time based on the energy requirement and a stored energy amount stored by the electric vehicle. Based on the grid data and the vehicle data, a strategy for charging and energy re-sale is generated, including selecting at least one charging location of the plurality of charging locations, and selecting at least one charging time for charging the electric vehicle at the selected charging location.

### FIELD

Embodiments relate to energy management, and more particularly to an energy management method for electric commercial vehicles, and related systems and devices.

### BACKGROUND

As electric vehicle usage and infrastructure continues to expand, efficient and cost-effective energy usage and management becomes increasingly valuable. Many charging locations have variable pricing and many locations also have the ability to sell or otherwise return unneeded energy to the grid, which may be based on a number of factors, such as time of day, demand, grid capacity, etc. In many applications, such as fleet or other commercial applications, mission planning and logistics can also be balanced against these energy management options. Accordingly, there is a need to provide a stationary vehicle energy management system that optimizes the vehicle energy situation when parked or charging.

### SUMMARY

According to an embodiment, an energy management method for an electric vehicle includes obtaining, from a grid interface, grid data indicative of an energy purchase price, an energy re-sale price, and a plurality of charging locations. The method further includes obtaining, from a vehicle management controller, vehicle data indicative of mission information, an energy requirement associated with the mission, and an estimated charging time based on the energy requirement and a stored energy amount stored by the electric vehicle. The method further includes generating, based on the grid data and the vehicle data, a strategy for charging and energy re-sale. The strategy includes selecting at least one charging location of the plurality of charging locations. The strategy includes selecting at least one charging time for charging the electric vehicle at the selected charging location.

According to another embodiment, an energy management system for an electric vehicle includes a processor circuit and a memory coupled to the processor circuit. The memory includes machine-readable instructions that, when executed by the processor circuit, cause the processor circuit to obtain, from a grid interface, grid data indicative of an energy purchase price, an energy re-sale price, and a plurality of charging locations. The instructions further cause the processor circuit to obtain, from a vehicle management controller, vehicle data indicative of mission information, an energy requirement associated with the mission, and an estimated charging time based on the energy requirement and a stored energy amount stored by the electric vehicle. The instructions further cause the processor circuit to generate, based on the grid data and the vehicle data, a strategy for charging and energy re-sale. The strategy includes machine-readable instructions that cause the processor circuit to select at least one charging location of the plurality of charging locations, select at least one charging time for charging the electric vehicle at the selected charging location. The instructions further cause the processor circuit to transmit information indicative of the strategy to the electric vehicle.

According to another embodiment, an electric vehicle includes a processor circuit and a memory coupled to the processor circuit. The memory includes machine-readable instructions that, when executed by the processor circuit, cause the processor circuit to obtain, from a grid interface, grid data indicative of an energy purchase price, an energy re-sale price, and a plurality of charging locations. The instructions further cause the processor circuit to obtain, from a vehicle management controller, vehicle data indicative of mission information, an energy requirement associated with the mission, and an estimated charging time based on the energy requirement and a stored energy amount stored by the electric vehicle. The instructions further cause the processor circuit to generate, based on the grid data and the vehicle data, a strategy for charging and energy re-sale. The strategy includes machine-readable instructions that cause the processor circuit to select at least one charging location of the plurality of charging locations, and select at least one charging time for charging the electric vehicle at the selected charging location. The instructions further cause the processor circuit to operate the electric vehicle based on the strategy to cause the electric vehicle to travel to the at least one selected charging location, and cause the electric vehicle to charge at the at least one selected charging station at the at least one selected time.

Other devices, methods, and systems according to embodiments will be or become apparent to one with skill in the art upon review of the following drawings and detailed description. It is intended that all such additional surface compaction machines, methods, and control systems be included within this description and protected by the accompanying claims. Moreover, it is intended that all embodiments disclosed herein can be implemented separately or combined in any way and/or combination.

### Aspects

According to an aspect, an energy management method for an electric vehicle includes obtaining, from a grid interface, grid data indicative of an energy purchase price, an energy re-sale price, and a plurality of charging locations. The method further includes obtaining, from a vehicle management controller, vehicle data indicative of mission information, an energy requirement associated with the mission, and an estimated charging time based on the energy requirement and a stored energy amount stored by the electric vehicle. The method further includes generating, based on the grid data and the vehicle data, a strategy for charging and energy re-sale. The strategy includes selecting at least one charging location of the plurality of charging locations. The strategy includes selecting at least one charging time for charging the electric vehicle at the selected charging location.

According to another aspect, the vehicle data further comprises charging current data associated with the plurality of charging locations, and ambient external temperature data associated the mission. The estimated charging time is further based on the charging current data and the ambient external temperature data.

According to another aspect, generating the strategy is further based on an estimated energy purchase price at the selected charging location for the selected charging time.

According to another aspect, the estimated energy purchase price for the charging location includes a carbon penalty component.

According to another aspect, selecting the charging location is further based on an estimated energy re-sale price at the selected charging location.

According to another aspect, selecting the charging time is further based on the estimated energy re-sale price at the selected charging location.

According to another aspect, the estimated energy re-sale price for the charging location includes a carbon offset component.

According to another aspect, the method further includes determining a change in at least one of the grid data or the vehicle data, and modifying the strategy based on the determined change in the at least one of the grid data or the vehicle data.

According to another aspect, modifying the strategy further includes selecting a different charging location of the plurality of charging locations based on the determined change in the at least one of the grid data or the vehicle data.

According to another aspect, modifying the strategy further includes selecting a different charging time based on the determined change in the at least one of the grid data or the vehicle data.

According to another aspect, an energy management system for an electric vehicle includes a processor circuit and a memory coupled to the processor circuit. The memory includes machine-readable instructions that, when executed by the processor circuit, cause the processor circuit to obtain, from a grid interface, grid data indicative of an energy purchase price, an energy re-sale price, and a plurality of charging locations. The instructions further cause the processor circuit to obtain, from a vehicle management controller, vehicle data indicative of mission information, an energy requirement associated with the mission, and an estimated charging time based on the energy requirement and a stored energy amount stored by the electric vehicle. The instructions further cause the processor circuit to generate, based on the grid data and the vehicle data, a strategy for charging and energy re-sale. The strategy includes machine-readable instructions that cause the processor circuit to select at least one charging location of the plurality of charging locations, select at least one charging time for charging the electric vehicle at the selected charging location. The instructions further cause the processor circuit to transmit information indicative of the strategy to the electric vehicle.

According to another aspect, the vehicle data further comprises charging current data associated with the plurality of charging locations, and ambient external temperature data associated the mission. The estimated charging time is further based on the charging current data and the ambient external temperature data.

According to another aspect, generating the strategy is further based on an estimated energy purchase price at the selected charging location for the selected charging time.

According to another aspect, selecting the charging location is further based on an estimated energy re-sale price at the selected charging location.

According to another aspect, selecting the charging time is further based on the estimated energy re-sale price at the selected charging location.

According to another aspect, an electric vehicle includes a processor circuit and a memory coupled to the processor circuit. The memory includes machine-readable instructions that, when executed by the processor circuit, cause the processor circuit to obtain, from a grid interface, grid data indicative of an energy purchase price, an energy re-sale price, and a plurality of charging locations. The instructions further cause the processor circuit to obtain, from a vehicle management controller, vehicle data indicative of mission information, an energy requirement associated with the mission, and an estimated charging time based on the energy requirement and a stored energy amount stored by the electric vehicle. The instructions further cause the processor circuit to generate, based on the grid data and the vehicle data, a strategy for charging and energy re-sale. The strategy includes machine-readable instructions that cause the processor circuit to select at least one charging location of the plurality of charging locations, and select at least one charging time for charging the electric vehicle at the selected charging location. The instructions further cause the processor circuit to operate the electric vehicle based on the strategy to cause the electric vehicle to travel to the at least one selected charging location, and cause the electric vehicle to charge at the at least one selected charging station at the at least one selected time.

According to another aspect, the vehicle data further comprises charging current data associated with the plurality of charging locations, and ambient external temperature data associated the mission. The estimated charging time is further based on the charging current data and the ambient external temperature data.

According to another aspect, generating the strategy is further based on an estimated energy purchase price at the selected charging location for the selected charging time.

According to another aspect, selecting the charging location is further based on an estimated energy re-sale price at the selected charging location.

According to another aspect, selecting the charging time is further based on the estimated energy re-sale price at the selected charging location.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a block diagram of a management system for managing charging of electric vehicles, according to some embodiments;

FIGS. 2A-2C are diagrams illustrating optimization of route selection for an electric vehicle based on mission locations and charging location availability and costs, according to some embodiments;

FIGS. 3A-3B are diagrams illustrating optimization of charging and usage strategies for an electric vehicle based on current energy requirements for a first time period, current and projected energy costs at different charging locations, and minimum energy requirements for a second time period, according to some embodiments; and

FIG. 4 is a flowchart of operations for an energy management method for an electric vehicle and management system, according to some embodiments.

### DETAILED DESCRIPTION OF EMBODIMENTS

Embodiments relate to energy management, and more particularly to an energy management method for electric commercial vehicles, and related systems and devices.

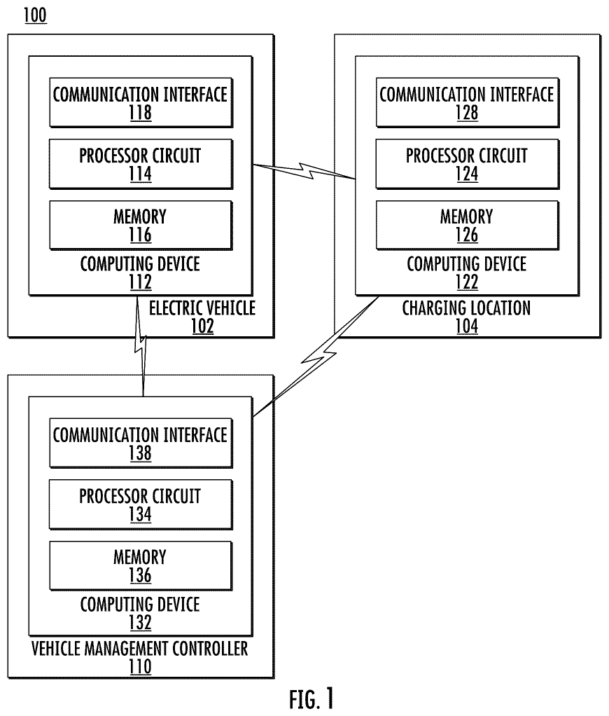

In this regard, FIG. 1 illustrates a block diagram of an electric vehicle management system 100 for managing charging of electric vehicles, according to some embodiments. In this example, the system 100 includes an electric vehicle 102 and a charging location 104 for facilitating charging of the electric vehicle 102. A vehicle management controller 110 is associated with the electric vehicle 102 for generating charging and energy usage strategies for the electric vehicle 102 based on mission information, energy requirements, and current and projected energy cost and re-sale prices during a time period associated with the energy usage strategy. It should be understood that the vehicle management controller 110 can be a component of the electric vehicle 102 and/or a separate component, device, or system, that communicates with components of the electric vehicle 102, as desired.

The electric vehicle 102 includes a vehicle computing device 112 that includes a processor circuit 114, a memory 116, and a communication interface 118, and the charging location includes a charging location computing device 122 that includes a processor circuit 124, a memory 126, and a communication interface 128. The communication interfaces 118, 128, 138 facilitate communicate with each other to transmit and/or receive data, commands, or other information therebetween. Communication can take place over a wired or wireless network or communication connection, as desired.

In this example, the vehicle management controller 110 is separate from the electric vehicle 102 and charging location 104, and includes a controller computing device 132 that includes a processor circuit 134, a memory 136, and a communication interface 138. In some embodiments, however, it should be understood, that the vehicle management controller 110 can be part of the electric vehicle 102 and/or charging location 104, and may employ a common computing device and/or computing components, as desired. It should also be understood that other systems or devices may be used with embodiments of the disclosure, such as stationary or movable industrial or construction equipment or other systems or devices for which optimization of energy usage and charging strategies may be advantageous.

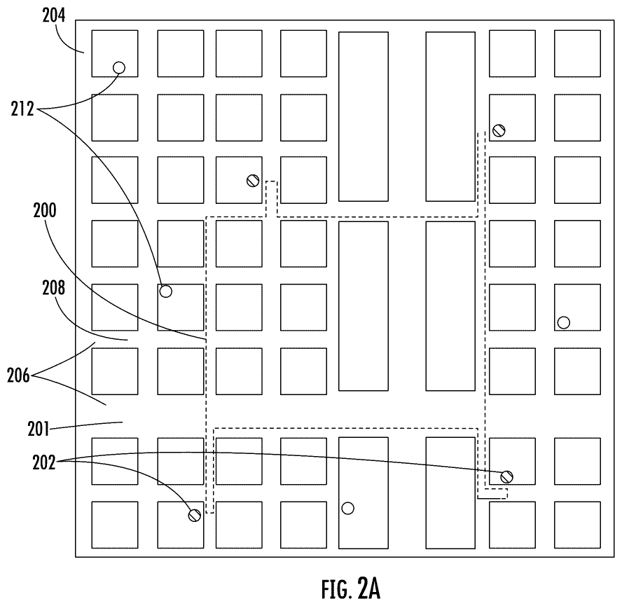

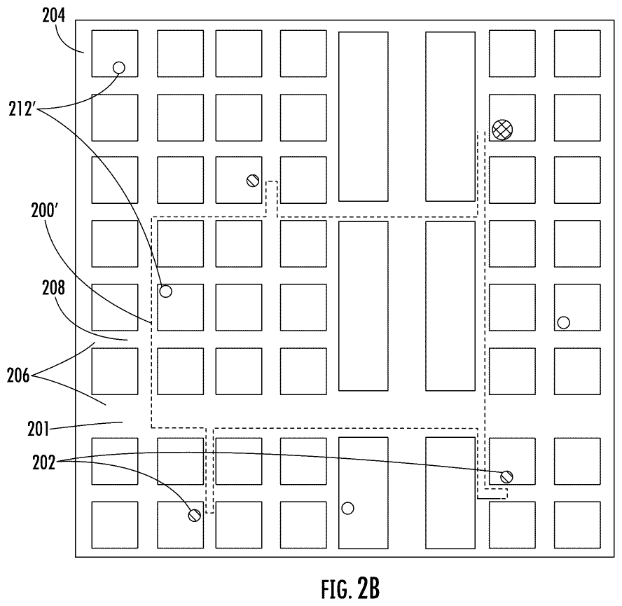

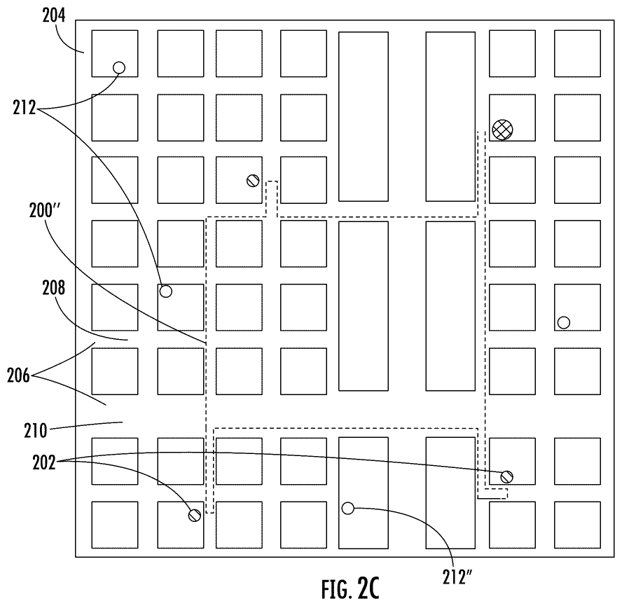

In some examples, various functions may be distributed across multiple computing devices, (e.g., computing devices 112, 122, 132). For example, strategic functions directed to long term planning and management (e.g., days or weeks) may include identification, generation, and/or modification of new and existing routes, assigning payloads to different vehicles based on vehicle criteria, such as vehicle weight, vehicle state, expected speed, etc., and/or establishing baseline mission routes (see, e.g., FIG. 2A below) that account for known constraints such as traffic patterns, restrictions on internal combustion engine usage, etc. Tactical functions related to short term planning and management (e.g., hours or minutes) may include modification or optimization of baseline mission routes based on changing conditions or vehicle requirements, energy management including absolute and relative energy prices, and real-time determination of vehicle location and energy purchase and re-sale prices at different charging locations (see, e.g., FIG. 2B below). Additional operational functions (e.g., less than one second or less than 25 meters of distance travelled) may include vehicle dynamics functions, such as speed management, automatic braking, obstacle avoidance, etc.

Referring now to FIGS. 2A-2C, diagrams illustrating optimization of route selection for an electric vehicle based on mission locations and charging location availability and costs are disclosed, according to some embodiments.

FIG. 2A illustrates a desired mission route 200 for an electric vehicle based on a number of stops at a plurality of mission locations 202 in a geographic area 204. In this example, the geographic area 204 includes a number of available roads 206, including local roads 208 and highways 210, and a plurality of charging locations 212.

In this example, the mission route 200 is selected based on a number of factors including minimizing energy usage, minimizing drive time, etc., and may also include a number of constraints, such as a requirement that the vehicle arrive at a particular mission location 202 as a specific time or time period, a requirement that a vehicle use or avoid certain roads (e.g., local roads 208, highways 210, etc.), or other requirements.

FIG. 2B illustrates an optimized mission route 200′ including a charging location 212′ selected based on certain criteria, such as the criteria discussed above for selecting the initial mission route 200, and/or other criteria, such as energy purchase price, energy re-sale price, internal or regulatory constraints (e.g., carbon penalties or incentives), and/or environmental conditions, such as ambient temperature or weather conditions, for example.

The optimized mission route 200′ includes a stop at a particular charging location 212′ at an expected time during the optimized mission route 200′, based on a number of criteria, such as an amount of available energy at the start of the optimized mission route 200′, an estimated energy purchase price and/or energy re-sale price at the particular charging location 212′ at the expected arrival time, expected environmental conditions such as ambient temperature (which can affect charging time and/or efficiency for example), minimizing a detour distance and/or time required for the stop at the charging location 212′, etc.

In some embodiments, it may be desirable to only purchase a minimum amount of energy that is required for a particular mission. It may also be desirable to purchase additional energy as a contingency against unexpected delays, detours, etc., with the option of selling back unneeded energy at the conclusion of the mission. By selecting particular charging locations 212 for particular expected arrival times, an optimized mission route 200′ can be optimized to take into account any number of criteria, such as expected energy purchase price, expected energy re-sale price, etc., for efficiently managing energy usage during the optimized mission route 200′. This optimization process may be fully or partially automated, as desired, including automatic generation of the mission route 200 and/or optimized mission route 200′, automated purchase and re-sale of energy, autonomous operation of vehicles, autonomous interaction with charging equipment at the charging locations 212′, etc. Other optimization criteria may include selection of different energy sources, including selecting a specific charging location 212 based on the availability or non-availability of green energy sources, such as wind or solar, with preference given toward these green energy sources, with a de-emphasis on the energy purchase price. For example, the optimized mission route 200′ may selected based on a preference for solar power, which may be available at the particular charging location 212′ at the expected arrival time.

Additional criteria may include taking internal or regulatory constraints, such as carbon penalties and/or available carbon offsets into account. For example, certain charging locations 212 may be disfavored based on their location within a high-density area and/or where the expected arrival time would be during a peak and/or restricted time period.

In some embodiments, the optimized mission route 200′ can be further optimized based on new or updated information. In this regard, FIG. 2C illustrates another optimized mission route 200″ that has been modified based on a detected change in one or more parameters associated with the original optimized mission route 200′ of FIG. 2B. In this example, it is determined that another charging location 212″ will have more favorable parameters, e.g., lower energy purchase prices, higher energy buy-back prices, etc. The determination may take into account an expected arrival time at the different charging locations 212, which may affect the expected parameters for the individual charging locations 212. For example, the original optimized route 202′ may have the vehicle arriving at charging location 212′ at a particular time, with a particular expected energy purchase price that is the lowest expected energy purchase price at that time. However, it may be determined that charging location 212″ may have an even lower expected energy purchase price when the vehicle is expected to be in the vicinity of that charging location 212″, thereby making it more favorable to include charging location 212″ in the modified optimized mission route 200″. In another example, the mission route 200 may be further modified to accommodate arrival at a particular charging location 212 at a particular time, for example reordering or changing the expected arrival times at mission locations 202, or stopping at multiple charging locations 212 at different times along the mission route 200. Using any number of criteria, charging locations 212 and arrival times can be selected and optimized for energy purchase price, energy re-sale price, energy usage, drive distance, and may take into account any number of different constraints, as desired.

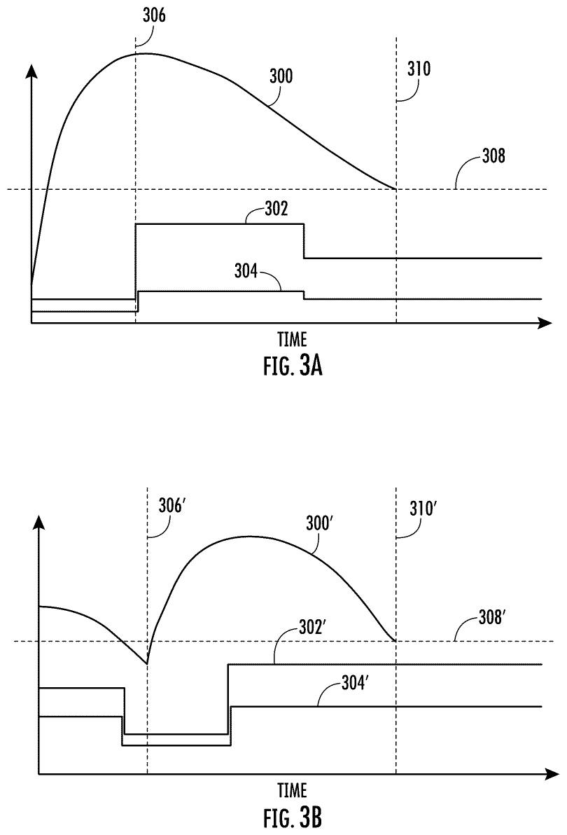

FIGS. 3A-3B are diagrams illustrating optimized charging and usage strategies for an electric vehicle, according to some embodiments. For example, FIG. 3A illustrates plots of available energy 300 over time based on a particular route and expected energy purchase price 302 and re-sale price 304 over time for a particular route. In this example, the expected energy purchase price 302 and energy re-sale price 304 corresponds to the nearest charging location to the expected location of the electric vehicle at that particular time. Thus, the energy purchase price 302 and energy re-sale price 304 will fluctuate at different locations and times along the particular route, based on the available charging locations at different times, and the different expected prices at those available charging locations during those times. In this example, it is determined that, based on the proposed route, it is desirable to charge the vehicle for a first time period 306 to increase the available energy 300 before proceeding on the mission route, which will provide enough available energy 300 so that the vehicle can complete its mission route and arrive at its final destination at a predetermined arrival time 310 with a predetermined minimum charge 308.

FIG. 3B illustrates plots of available energy 300′ over time based on a particular route and expected energy purchase price 302′ and re-sale price 304′ over time for a different route. In this example, it is determined that, based on the proposed mission route, the vehicle has enough available energy 300′ to complete the route and arrive at its final destination with energy in excess of the predetermined minimum charge 308′. Based on this information, it is desirable to proceed on the mission route using available energy 300′, with a stop at a particular charging location at an expected time or time period 306′ during the mission route, for re-sale of the excess energy, while leaving the electric vehicle with enough available energy 300′ and time to complete its mission route and arrive at its final destination by a predetermined arrival time 310′ with the predetermined minimum charge 308′.

These and other types of determinations can be performed for a number of different potential routes using any number of data processing or prediction techniques, including using artificial intelligence or machine learning techniques for example, to determine and optimize the mission route for one or more parameters, such as minimizing the cost of purchased energy, maximizing energy re-sale, or other factors, as desired. Additional criteria that can be used include selection of different charging locations based on location, relative distance, local traffic laws (e.g., speed limits), expected delays (e.g., due to traffic and/or construction), and/or road type, etc. Energy purchase and/or re-sale price criteria can include a current price (e.g., price per kW), an expected price based on a set schedule and/or prediction technique, a maximum, average purchase price over a predetermined time period, carbon penalties and/or available carbon offsets, etc. Energy requirement criteria for a particular mission may include total energy needed to complete the mission, optimized energy usage based on speed limits, city/highway efficiency considerations, a maximum energy capacity for the electric vehicle, energy reserve requirements for the electric vehicle, etc. Mission information criteria may include total distance for the mission, a total number of stops, a maximum time for the mission, specific arrival and/or departure times for specific stops, etc. Charging time criteria may include the charging capabilities of the vehicle and/or the charging capabilities of different charging locations, etc. Charging location selection criteria may include charging capabilities (e.g., charging current, available charging interfaces), current or expected vehicle capacity at the charging location (e.g., number of available bays/charging interfaces), current or expected traffic, and/or expected reliability (e.g., expected downtime) for the charging location.

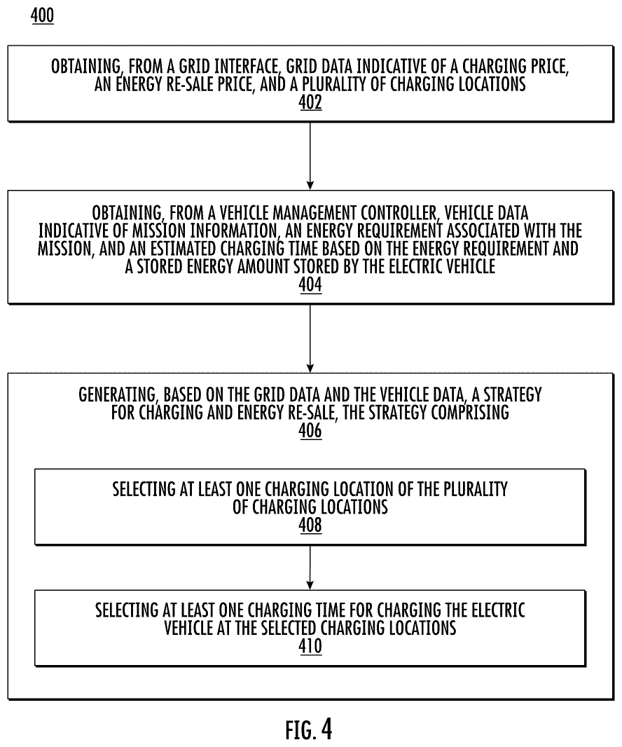

Referring now to FIG. 4 is a flowchart of operations for an energy management method for an electric vehicle and management system, according to some embodiments. In particular, reference will also be made to features of the embodiments described in FIGS. 2A-3B above.

The operations 400 may include obtaining, from a grid interface, grid data indicative of a, energy purchase price, an energy re-sale price, and a plurality of charging locations (Block 402). For example, the optimized mission route 200′, 200″ of FIGS. 2A-2C may use obtained grid data to determine these and other parameters for use during the mission optimization process. The energy purchase prices 302 and energy re-sale prices 304 of FIG. 3A-3B may also be based on obtained grid data, as desired. As used herein, the term “grid interface” may refer to a network interface that facilitates communication with a transmission grid network, station network, or similar network.

The operations 400 may further include obtaining, from the electric vehicle, vehicle data indicative of mission information, an energy requirement associated with the mission, and an estimated charging time based on the energy requirement and a stored energy amount stored by the electric vehicle (Block 404). In some examples, the vehicle data may also include charging current data associated with the plurality of charging locations, and ambient external temperature data associated the mission, with the estimated charging time is further based on the charging current data and the ambient external temperature data.

The operations 400 may further include generating, based on the grid data and the vehicle data, a strategy for charging and energy re-sale (Block 406), as described in detail above with respect to the examples of FIGS. 2A-3C. For example, generating the strategy may further include selecting at least one charging location of the plurality of charging locations (Block 408), such as by comparing charging locations based on an estimated energy purchase price at the different charging location for the different charging times. In some examples, as discussed above, the estimated energy purchase price for the charging location includes a carbon penalty component.

Alternatively, or in addition, generating the strategy may further include selecting at least one charging time for charging the electric vehicle at the selected charging location (Block 410). Selecting the charging location and/or charging time may be further based on an estimated energy re-sale price at the selected charging location. As discussed above as well, the estimated energy re-sale price for the charging location may include a carbon offset component.

In some examples, as described in detail with respect to FIG. 2C above, the strategy may be modified based on the determined change in the at least one of the grid data or the vehicle data. For example, modification may include selecting a different charging location and/or charging time based on the determined change in the at least one of the grid data or the vehicle data.

Some embodiments above describe optimization of charging and energy re-sale strategies for electric vehicles, such as cargo trucks, but it should be understood that any vehicles or combination of vehicles may employ features of the embodiments described herein. As used herein, a “vehicle” refers to a thing used for transporting goods and/or people, and may include motorized vehicles, such as trucks, automobiles, and/or motorized construction equipment, and non-motorized vehicles, such as trailers, carts, and/or dollies, for example.

When an element is referred to as being “connected”, “coupled”, “responsive”, “mounted”, or variants thereof to another element, it can be directly connected, coupled, responsive, or mounted to the other element or intervening elements may be present. In contrast, when an element is referred to as being “directly connected”, “directly coupled”, “directly responsive”, “directly mounted” or variants thereof to another element, there are no intervening elements present. Like numbers refer to like elements throughout. As used herein, the singular forms “a”, “an” and “the” are intended to include the plural forms as well, unless the context clearly indicates otherwise. Well-known functions or constructions may not be described in detail for brevity and/or clarity. The term “and/or” and its abbreviation “/” include any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but do not preclude the presence or addition of one or more other features, integers, elements, steps, components, functions or groups thereof. Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id est,” may be used to specify a particular item from a more general recitation.

Persons skilled in the art will recognize that certain elements of the above-described embodiments may variously be combined or eliminated to create further embodiments, and such further embodiments fall within the scope and teachings of inventive concepts. It will also be apparent to those of ordinary skill in the art that the above-described embodiments may be combined in whole or in part to create additional embodiments within the scope and teachings of inventive concepts. Thus, although specific embodiments of, and examples for, inventive concepts are described herein for illustrative purposes, various equivalent modifications are possible within the scope of inventive concepts, as those skilled in the relevant art will recognize. Accordingly, the scope of inventive concepts is determined from the appended claims and equivalents thereof.

1. An energy management method for an electric vehicle, the method comprising:
obtaining, from a grid interface, grid data indicative of an energy purchase price, an energy re-sale price, and a plurality of charging locations;
obtaining, from a vehicle management controller, vehicle data indicative of mission information, an energy requirement associated with the mission, and an estimated charging time based on the energy requirement and a stored energy amount stored by the electric vehicle; and
generating, based on the grid data and the vehicle data, a strategy for charging and energy re-sale, the strategy comprising:
selecting at least one charging location of the plurality of charging locations; and
selecting at least one charging time for charging the electric vehicle at the selected charging location.

2. The energy management method of claim 1, wherein the vehicle data further comprises charging current data associated with the plurality of charging locations, and ambient external temperature data associated the mission, and
wherein the estimated charging time is further based on the charging current data and the ambient external temperature data.

3. The energy management method of claim 1, wherein generating the strategy is further based on an estimated energy purchase price at the selected charging location for the selected charging time.

4. The energy management method of claim 3, wherein the estimated energy purchase price for the charging location includes a carbon penalty component.

5. The energy management method of claim 1, wherein selecting the charging location is further based on an estimated energy re-sale price at the selected charging location.

6. The energy management method of claim 5, wherein selecting the charging time is further based on the estimated energy re-sale price at the selected charging location.

7. The energy management method of claim 5, wherein the estimated energy re-sale price for the charging location includes a carbon offset component.

8. The energy management method of claim 1, further comprising:
determining a change in at least one of the grid data or the vehicle data; and
modifying the strategy based on the determined change in the at least one of the grid data or the vehicle data.

9. The energy management method of claim 8, wherein modifying the strategy further comprises:
selecting a different charging location of the plurality of charging locations based on the determined change in the at least one of the grid data or the vehicle data.

10. The energy management method of claim 8, wherein modifying the strategy further comprises:
selecting a different charging time based on the determined change in the at least one of the grid data or the vehicle data.

11. An energy management system for an electric vehicle, the system comprising:
a processor circuit; and
a memory coupled to the processor circuit, the memory comprising machine-readable instructions that, when executed by the processor circuit, cause the processor circuit to:
obtain, from a grid interface, grid data indicative of an energy purchase price, an energy re-sale price, and a plurality of charging locations;
obtain, from a vehicle management controller, vehicle data indicative of mission information, an energy requirement associated with the mission, and an estimated charging time based on the energy requirement and a stored energy amount stored by the electric vehicle; and
generate, based on the grid data and the vehicle data, a strategy for charging and energy re-sale, the strategy comprising machine-readable instructions that cause the processor circuit to:
select at least one charging location of the plurality of charging locations; and
select at least one charging time for charging the electric vehicle at the selected charging location; and
transmit information indicative of the strategy to the electric vehicle.

12. The energy management system of claim 11, wherein the vehicle data further comprises charging current data associated with the plurality of charging locations, and ambient external temperature data associated the mission, and
wherein the estimated charging time is further based on the charging current data and the ambient external temperature data.

13. The energy management system of claim 11, wherein generating the strategy is further based on an estimated energy purchase price at the selected charging location for the selected charging time.

14. The energy management system of claim 11, wherein selecting the charging location is further based on an estimated energy re-sale price at the selected charging location.

15. The energy management system of claim 14, wherein selecting the charging time is further based on the estimated energy re-sale price at the selected charging location.

16. An electric vehicle comprising:
a processor circuit; and
a memory coupled to the processor circuit, the memory comprising machine-readable instructions that, when executed by the processor circuit, cause the processor circuit to:
obtain, from a grid interface, grid data indicative of an energy purchase price, an energy re-sale price, and a plurality of charging locations;
obtain, from a vehicle management controller, vehicle data indicative of mission information, an energy requirement associated with the mission, and an estimated charging time based on the energy requirement and a stored energy amount stored by the electric vehicle;
generate, based on the grid data and the vehicle data, a strategy for charging and energy re-sale, the strategy comprising machine-readable instructions that cause the processor circuit to:
select at least one charging location of the plurality of charging locations; and
select at least one charging time for charging the electric vehicle at the selected charging location; and
operate the electric vehicle based on the strategy to:
cause the electric vehicle to travel to the at least one selected charging location; and
cause the electric vehicle to charge at the at least one selected charging station at the at least one selected time.

17. The electric vehicle of claim 16, wherein the vehicle data further comprises charging current data associated with the plurality of charging locations, and ambient external temperature data associated the mission, and
wherein the estimated charging time is further based on the charging current data and the ambient external temperature data.

18. The electric vehicle of claim 16, wherein generating the strategy is further based on an estimated energy purchase price at the selected charging location for the selected charging time.

19. The electric vehicle of claim 16, wherein selecting the charging location is further based on an estimated energy re-sale price at the selected charging location.

20. The electric vehicle of claim 19, wherein selecting the charging time is further based on the estimated energy re-sale price at the selected charging location.
